(19) United States
(12) Patent Application Publication
(10) Pub. No.: US 2009/0137205 A1
(43) Pub. Date: May 28, 2009

(54) DEVICE, SYSTEM AND METHOD FOR PRESENTING DATA TO A USER

(76) Inventors: Johan Van Ketwich, Malmo (SE); Anna Nordstrom, Malmo (SE)

Correspondence Address: WARREN A. SKLAR (SOER);RENNER, OTTO, BOISSELLE & SKLAR, LLP, 1621 EUCLID AVENUE, 19TH FLOOR, CLEVELAND, OH, 44115, US

(21) Appl. No.: 11/944,501

(22) Filed: Nov. 23, 2007

(51) Int. Cl. H04B 7/00

(52) U.S. Cl. 455/41.2

(57) ABSTRACT

The invention relates to a portable device comprising:
a communication unit arranged to wirelessly receive first data from a short range activating element,
a receiving unit configured to receive second data,
a processing unit arranged to activate an application indicated by said first data, the application being arranged to use said first data to retrieve the second data and to process the second data from the receiving unit, and
an output unit is arranged to output the processed second data.

### FIELD OF THE INVENTION

The invention relates to a device, a system and a method for presenting data to a user. In particular, the invention relates to present information to a user via a portable device.

### BACKGROUND OF THE INVENTION

Today, there is an increase in the demand of electronic devices. Different electronic devices such as portable devices find their way into all different kinds of areas. Especially, the use of portable devices, such as PDAs, mobile phones, MP3-players and the like, is increasing tremendously. As the use of portable devices increases, different functions are requested in the portable devices taking advantage of the fact that the device is portable and easy to carry around. For example, when a user/visitor today visits a site, such as a museum or the like, the user looks at an information display informing the visitor of certain information, watches a video clip running on a monitor arranged to the side of a painting or the like. However, the experience of visiting certain sites or events may appear dull and not very exiting as, for example, the video clips are on repeat and are hard to hear in a crowd, as well as the display case may appear quite and uninteresting.

Hence, in today's market for electronic devices and terminals, there is a growing demand for increasing possibilities of attractive and flexible functions of the device.

### SUMMARY OF THE INVENTION

Embodiments of the present invention address the problem of providing a portable device having increased possibilities of attractive and flexible functions.

An embodiment relates to a portable device comprising a communication unit arranged to wirelessly receive first data from a short range activating element, a receiving unit configured to receive second data, a processing unit arranged to activate an application indicated by said first data, the application being arranged to use said first data to retrieve the second data and to process the second data from the receiving unit, and an output unit is arranged to output the processed second data.

The first data may be data indicating the settings of the application required to receive the second data and the application may be arranged to use the settings.

In an embodiment the first data is data indicating a list of different settings of the application and wherein the application is arranged to use a setting from the list based on a local setting of the portable device.

In addition, the second data may be outputted as audio over an audio arrangement.

The communication unit may be a short range communication unit.

In an embodiment the communication unit is a near field communication unit (NFC).

The application may be a media application or a browser application.

The second data may be a media stream, such as an FM radio stream.

The second data may be a web page, wherein the web page may contain a media player enabled to receive streamed media data.

In an embodiment the receiving unit and the output unit may be arranged as one arrangement.

An embodiment is a short range communication tag comprising data arranged to be retrieved by a portable device transferred from the tag wherein the data indicates an application to be executed on the portable device and settings used in the application.

The tag may be a near field communication tag.

In an embodiment, the first data is a commando to initiate an application and a frequency or web address to use in said application.

Furthermore, the first data may comprise a list of different settings wherein each setting is related to a setting of the portable device.

An embodiment is a system arranged to render information to a user comprising a portable device comprising a communication unit arranged to receive first data through a wireless interface from a short range activating element, a receiving unit configured to receive second data, a processing unit arranged to activate an application indicated by said first data, the application being arranged to use said first data to retrieve the second data and to process the second data from the receiving unit, and an output unit is arranged to output the processed second data, wherein the system further comprises a short range activating element arranged to provide the portable device with the first data indicating the application, and a transmission device arranged to transmit the second data.

In an embodiment, the short range activating element may be a short range communication tag comprising first data arranged to be retrieved by a portable device transferred from the tag wherein the first data indicates an application to be executed on the portable device and settings used in the application

In an embodiment, the transmission device may be a broadcasting unit or a server.

An embodiment is a method for transmitting data to a user of a portable device, comprising the steps of positioning the portable device within an activation area of an activator element, receiving first data in the portable device from the activator element, activating an application in the portable device according to received first data, using said first data in the application to enable the portable device to receive second data, receiving the second data in the portable device over the air, processing the second data in the application of the portable device, transferring the processed data to an output unit in the portable device, and outputting the processed data to the user from the output unit.

In addition, the second data may be outputted to the user on a display and/or an audio arrangement.

### BRIEF DESCRIPTION OF THE DRAWINGS

The invention, together with further objectives and advantages thereof, may best be understood by reference to the following description taken in conjunction with the accompanying drawings in which:

FIG. 1 shows a schematic overview of a system of an embodiment of the invention,

FIG. 2 shows a schematic overview of a system of an embodiment of the invention,

FIG. 3 shows a schematic overview of an embodiment of a portable device, and

FIG. 4 shows a schematic flow chart of an embodiment of the invention.

### DETAILED DESCRIPTION OF THE DRAWINGS

Embodiments of the present invention will be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms used herein should be interpreted as having a meaning that is consistent with their meaning in the context of this specification and the relevant art and will not be interpreted in an idealized or overly formal sense unless expressly so defined herein.

The present invention is described herein as employed in and with a wireless communications device, also denoted a portable device. In the context of the invention, the portable device may e.g. be a mobile phone, a PDA (Personal Digital Assistant) or any other type of portable computer such as laptop computer.

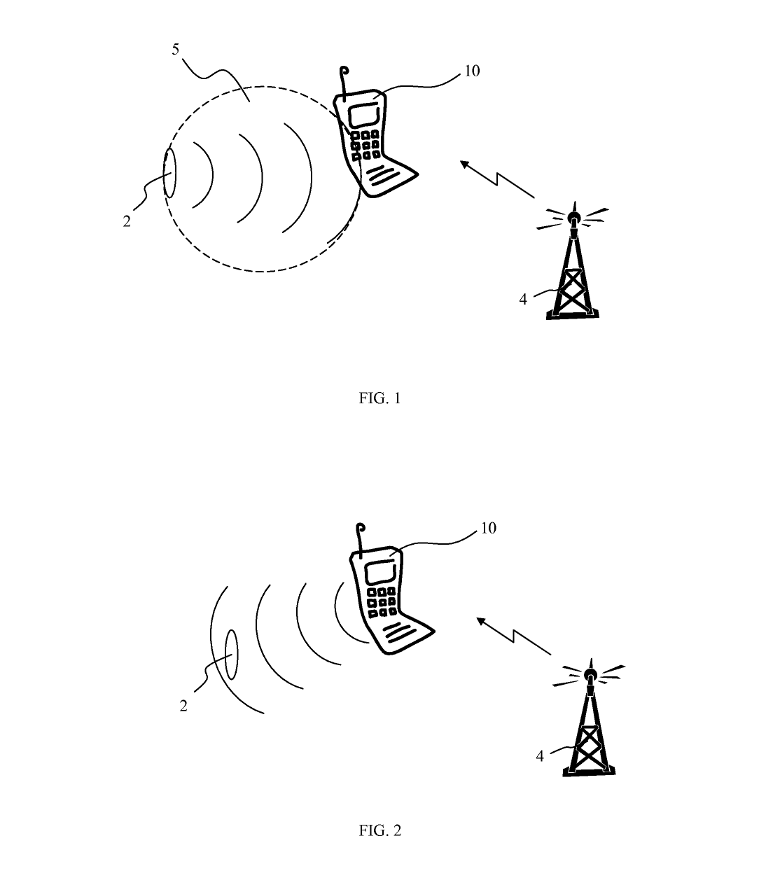

In FIG. 1 a schematic system is disclosed comprising an activator element 2, such as a near field communication tag (NFC) or the like, that may actively induce an electromagnetic field over an area 5. As a person carrying a portable device 10 introduces the device 10 within the area 5, a communication unit 30, such as a NFC reader or the like, in said portable device 10 is activated by the electromagnetic field and receives data from the NFC tag 2. NFC communication is enabled by bringing two NFC compatible devices within a few centimeters of one another. The data indicates that the portable device 10 should automatically initiate a radio receiving application stored/installed in the portable device. The first data also indicates what frequency and/or frequency band the application should use as its settings. The application tunes in to a transmission using the settings and receives first data from a broadcasting antenna 4 or the like. The broadcasted data is then rendered in audible or visual form to the user of the portable device via said application.

In FIG. 2, a schematic system is shown wherein a portable device 10 comprises an active communication unit. The active communication unit has a certain range of communication, up to 30 cm, and retrieves first data from the activator element 2, for example, when a handshake has been performed. The data, as in FIG. 1, is transferred over the connection between two NFC devices, which is established at once, and used to start up an application in the portable device 10 and use settings from the retrieved data to tune in the application to receive second data from a transmitter 4. The second data is then processed in the portable device 10 and outputted to the user over an audio arrangement, such as speakers, earphones or the like. In the embodiment of FIG. 2 the activator element is passive, that is, the activator is activated by the induced electromagnetic field from the portable device. This is useful in implementations wherein the activator element is installed on objects without an energy source or a small energy source, such as on a ticket, an information folder or the like.

An exemplary implementation of the embodied system in FIG. 1 will now be described. A person visiting a museum is entering an exhibition hall of the museum. The exhibition exhibits different eras in history and certain main events taken place in history. As the person reaches a certain display case, for example, displaying a battle field, the person picks up his portable device 10 and places the portable device 10 in the vicinity of a marked area arranged on a wall or the like next to the display case. The portable device then uses the information received at the portable device 10 from the NFC tag 2 to initiate a radio application in the portable device 10. The radio application is set to a FM frequency indicated in the received data and the user may listen to the audio information broadcasted on that frequency using, for example, earphones.

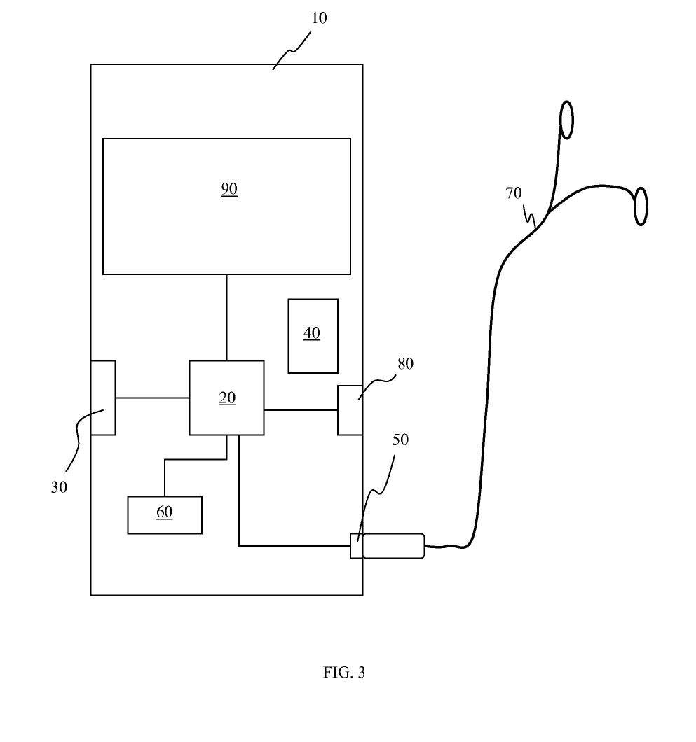

In FIG. 3 an embodiment of a portable device 10 is shown. The portable device 10 comprises a processor unit 20, such as a CPU, FPGA or the like, a communication unit, such as a NFC-reader, RFID-reader or the like, an energy source 40, an output port 50, such as an earphone output or the like, a memory unit 60, earphones 70, a receiving unit 80 such as antenna or the like, and a display unit 90, such as a display screen, touch screen or the like. It should be understood that the receiving unit 90 may be implemented in the earphones 70.

The embodied portable device 10 functions in the following manner: As the person that carries the portable device 10 positions the portable device 10 within an electromagnetic field of an activator element, such as an NFC tag, the communication unit 30 is exited and receives a first type of data from the NFC tag. The data contains information on what application to execute and to use preset settings in the application. The processor 20 receives the first data and retrieves the indicated application from its memory 60 wherein the application is stored and the application is executed on the processor 20 using the settings for the application received from the tag. The communication unit may be energised by the energy source 40, such as the battery of the device 10.

The application, for example, being a radio application, receives a second type of data, such as audio data, over the air interface using the receiving unit 80 as a receiver. The second data is processed in the processor 20 and outputted to the output port 50 as electric signals. It should here be noted that the output arrangement may be a speaker arrangement, a display or the like arranged in the portable device.

The electrical signals are outputted to the user through the earphones 70 so that information may be rendered to the user.

In a different implementation the data received from the electromagnetic tag is indicating to start up a web browser stored in the memory 60 of the device and a web address to retrieve a web site. The website is displayed in the display 90 of the portable device carrying information to the user in text, but may also include audio information played back to the user via the earphones 70 or the like. The audio information may be embedded in the web page or a media player may be displayed in the web page. The second type of data may be retrieved through any known communication technology such as WCDMA, GPRS, or the like. This enhances the whole experience of visiting certain information displays, such as museum displays, information boards, advertising signs, event folders or the like.

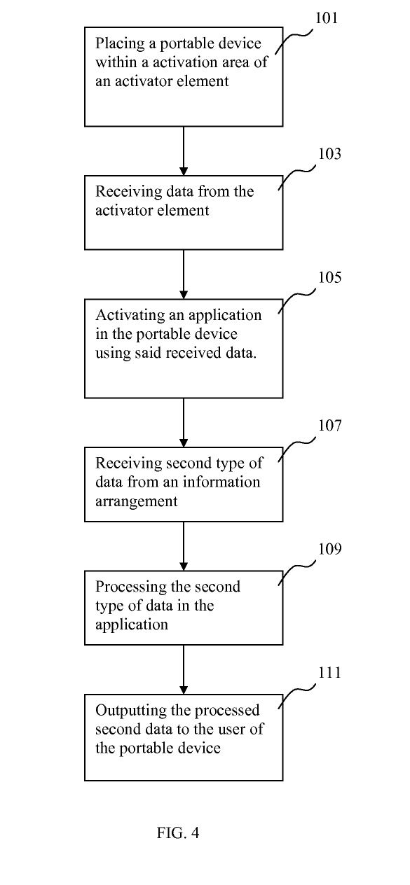

In FIG. 4 a schematic flow chart of a method for outputting added value information to a user is illustrated.

In step 101, a user carrying a portable device, such as mobile terminal, mp3 player or the like, places the portable device within an activation area of an activator element, for example, an NFC tag. An NFC tag has an activation area in the range up to 30 cm.

In step 103, the portable device receives data from the activator element indicating that an application should be initiated and further comprising setting/s for the application.

In step 105, the indicated application is initiated in the portable device with the setting/s indicated in the received data. The application may be, for example, a radio application, a television application, a web browser or the like, and the setting being, for example, a frequency, a URL or the like. The URL may be a web site of a web radio or the like. The application is arranged to receive or retrieve a second type of data from an information arrangement, such as a server, radio station, television station, local broadcast transmitter or the like.

In step 107, the device receives the second type of data from the information arrangement, wherein the second type of data is, for example, a radio cast or the like.

In step 109, the data is processed in the application, resulting in a media stream, such as audio signals or the like, or a web page data.

In step 111, the processed data is sent to an output arrangement, such as a display, a speaker, an output port, or a combination thereof, wherein the information is outputted to the user of the portable device.

In an embodiment an activator element is arranged on a ticket to a sports game. As a spectator sometimes gets caught in traffic or the like, the game sometimes starts before the spectator reaches the arena. As an added value service, a ticket may comprise an activator element that passively activates, in order not to have to comprise an energy source, an application of a portable device when the communication element of the portable device is put close to the activator element. The application may be a radio application, an Internet browser with an address to a web cast of the game or the like. Hence, a spectator that is stuck somewhere will, by putting the reader element of the portable device in vicinity of the activator element, receive a live broadcast of the game in the portable device, by audio, text or the like.

Referring back to FIGS. 1-3, an NFC system may be embodied in different modes, such as a Passive Communication Mode, wherein an electromagnetic activator device 2 or 30 provides a carrier field and a target device 30 or 2 answers by modulating the existing field. In this mode, the target device 30 or 2 may draw its operating power from the electromagnetic field 5 provided from the activator, thus, making the target device 30 or 2 a transponder.

An NFC system may also be embodied in an Active Communication Mode, wherein both activator and target device communicate by alternately generating their own field. A device deactivates its field while it is waiting for data. In this mode, both devices typically need to have a power supply.

In an embodiment a listening device, such as earphones, is arranged in the portable device in order to output the received broadcasted data, wherein the listening device is also arranged to function as a receiver of the broadcasted data.

It should be understood that the activator element may be a NFC-tag, RFID tag, Bluetooth unit or any short range communication unit. The tag is programmed with information such as a command to start up a receiving application and source data, such as a frequency, a web address or the like, to use as a setting in the receiving application.

In the same manner the communication unit of the portable device may be a NFC tag, RFID tag, Bluetooth unit or any short range communication unit.

Additionally, the data transferred to the portable device may in an embodiment comprise a numerous of frequencies or other settings wherein each frequency is related to a local setting of the portable device, such as language setting. In this manner, a user of a portable device with the Spanish language setting of the portable device may receive a Spanish broadcast/webcast, whereas a user with a portable device set on English language will receive an English broadcast/webcast.

The list may comprise indications to which local setting of the portable device the setting relates to. The application will compare the indications of the list to find a match that corresponds to the local setting of the portable device. If no match is found the list may contain a default setting to be used.

In an embodiment an NFC tag contains merely a web address or a frequency wherein the portable device is arranged with an application that the received web address or frequency indicates that a web browser or radio application should be executed with the web address or the frequency set as its setting.

It should be noted that the receiving unit in the portable device may a transceiving unit or that the portable device has a separated transmitting unit in order to transmit a web address or the like to enable the retrieval of the second data.

Furthermore, the portable device may be adapted for selection of one out of a plurality of simultaneously detected communications networks in order to receive the second type of information. In this context, a communications network may e.g. be an IEEE 802.11 type WLAN, a WiMAX, a HiperLAN, a Bluetooth LAN, or a cellular mobile communications network such as a GPRS network, or a third generation WCDMA network. Given the rapid development in communications, there will of course also be future type wireless communications networks with which the present invention may be embodied, but the actual design and function of the network is not of primary concern for the invention, which involves the actual process of selection of one out of a plurality of accessible networks.

The foregoing has described the principles, preferred embodiments and modes of operation of the present invention. However, the invention should be regarded as illustrative rather than restrictive, and not as being limited to the particular embodiments discussed above. It should therefore be appreciated that variations may be made in those embodiments by those skilled in the art without departing from the scope of the present invention as defined by the following claims.

1. A portable device comprising:
a communication unit arranged to wirelessly receive first data from a short range activating element,
a receiving unit configured to receive second data,
a processing unit arranged to activate an application indicated by said first data, the application being arranged to use said first data to retrieve the second data and to process the second data from the receiving unit, and
an output unit is arranged to output the processed second data.

2. A portable device according to claim 1, wherein the first data is data indicating the settings of the application required to receive the second data and the application is arranged to use the settings.

3. A portable device according to claim 1, wherein the first data is data indicating a list of different settings of the application and wherein the application is arranged to use a setting from the list based on a local setting of the portable device.

4. A portable device according to claim 1, wherein the second data is outputted as audio over an audio arrangement.

5. A portable device according to claim 1, wherein the communication unit is a short range communication unit.

6. A portable device according to claim 1, wherein the communication unit is a near field communication unit (NFC).

7. A portable device according to claim 1, wherein the application is a media application or a browser application.

8. A portable device according to claim 7, wherein the second data comprises a media stream, such as an FM radio stream or the like.

9. A portable device according to claim 7, wherein the second data comprises a web page.

10. A short range communication tag comprising first data arranged to be retrieved by a portable device transferred from the tag wherein the first data indicates an application to be executed on the portable device and settings used in the application.

11. A communication tag according to claim 10, wherein the tag is a near field communication tag.

12. A communication tag according to claim 10, wherein the first data comprises a list of different settings wherein each setting is related to a setting of the portable device.

13. A communication tag according to claim 10, wherein the first data is a commando to initiate an application and a frequency or web address to use in said application.

14. A system arranged to render information to a user comprising a portable device comprising a
a communication unit arranged to receive first data through a wireless interface from a short range activating element,
a receiving unit configured to receive second data,
a processing unit arranged to activate an application indicated by said first data, the application being arranged to use said first data to retrieve the second data and to process the second data from the receiving unit, and
an output unit is arranged to output the processed second data,
wherein the system further comprises a short range activating element arranged to provide the portable device with the first data indicating the application, and a transmission device arranged to transmit the second data.

15. A system according to claim 14, wherein the short range activating element is a short range communication tag comprising first data arranged to be retrieved by a portable device transferred from the tag wherein the first data indicates an application to be executed on the portable device and settings used in the application

16. A system according to claim 14, wherein the transmission device is a broadcasting unit.

17. A portable device according to claim 14, wherein the transmission device is a server.

18. A method for transmitting data to a user of a portable device, comprising the steps of:
positioning the portable device within an activation area of an activator element,
receiving first data in the portable device from the activator element,
activating an application in the portable device according to received first data,
using said first data in the application to enable the portable device to receive second data,
receiving the second data in the portable device over the air,
processing the second data in the application of the portable device,
transferring the processed data to an output unit in the portable device, and
outputting the processed data to the user from the output unit.

19. A method according to claim 20, wherein in the second data is outputted to the user on a display and/or an audio arrangement.
